(19) United States
(12) Patent Application Publication
(10) Pub. No.: US 2011/0179961 A1
(43) Pub. Date: Jul. 28, 2011

(54) PRINTING APPARATUS, PRINTING METHOD, AND STORAGE MEDIUM CAPABLE OF MAKING QUALITY INSPECTION

(75) Inventor: Katsuhiko YANAGAWA, Inagi-shi (JP)

(73) Assignee: CANON KABUSHIKI KAISHA, Tokyo (JP)

(21) Appl. No.: 12/984,676

(22) Filed: Jan. 5, 2011

(30) Foreign Application Priority Data
Jan. 28, 2010 (JP) 2010-016571

(51) Int. Cl. B41F 33/00

(52) U.S. Cl. 101/483

(57) ABSTRACT

A printing apparatus capable of improving the printing quality and at the same time reducing the printing failure occurrence rate. An inspection controller of the printing apparatus causes an image reader to read plural pages, which are printed on a sheet according to first image data from a host computer, and generates second image data based on a result of the reading. The inspection controller detects, based on the first and second image data, an amount of printing displacement on each page printed on the sheet, and determines whether the detected amount of printing displacement on each page falls within an allowable range defined by an allowable value. If a saddle-stitching book-binding process is specified in print settings, the allowable value is changed between particular pages where there is an image in a peripheral area around a folded sheet portion and other pages.

### BACKGROUND OF THE INVENTION

1. Field of the Invention

The present invention relates to a printing apparatus, a printing method, and a storage medium, which are capable of inspecting defective printing of a printed product.

2. Description of the Related Art

In the commercial printing industry and in the POD (print on demand) market, an inspection must be made to check for a deficiency in a printed product to be delivered to customer. At the present time, however, inspection is not fully automated and printed products are each manually checked by an operator. In the case of a printed product of several hundred pages, enormous time and effort are required to check each page of the printed product in detail, and therefore a rough inspection is performed in practice, resulting in a problem that slight printing error, missing print, paper stain, etc. cannot be detected.

Under these circumstances, a technique for automatically inspecting a printed product has been demanded, and an inspection apparatus is known that inspects a printed product by comparing picked-up images of the printed product with inspection images (Japanese Laid-open Patent Publication No. H 11-39492).

Due to a mechanical inaccuracy in sheet conveyance in a printing apparatus, a printing position on a sheet is sometimes displaced. To obviate this, a printing apparatus is known in which an amount of printing position displacement is detected, and printing is interrupted if the detected amount of displacement exceeds a predetermined maximum allowable value (Japanese Laid-open Patent Publication No. 2008-52115).

Meanwhile, a printing apparatus is able to fold printed sheets, which are bound at their center portions, into two to create a booklet such as that shown in FIG. 12A.

The booklet shown in FIG. 12A is formed by first and second sheets respectively denoted by symbols “sheet1” and “sheet2” and has first to third double-spread pages. The first double-spread page is formed by a front surface P1 of a left half of a first sheet and a rear surface of a left half of a second sheet, the second double-spread page is formed by front surfaces P3, P4 of left and right halves of the second sheet, and the third double-spread page is formed by a rear surface of the right half of the second sheet and a front surface P6 of a right half of the first sheet. Accordingly, only the innermost double-spread page is formed by one sheet, and the other double-spread pages are each formed by two sheets. This applies not only to the booklet formed by two sheets, but also to a booklet formed by three or more sheets.

A printing displacement of an image, which is formed on a double-spread page formed by two sheets so as to extend across these sheets, becomes noticeable at a boundary between the two sheets, even if the printing displacement occurring on one or both of the sheets is small. For example, poor printing appearance is caused, if a printing displacement such as that shown in FIG. 12D or 12E occurs on two sheets on which printing should be originally made as shown in FIG. 12B or 12C. Such a problem can be prevented by using the printing technique disclosed in Japanese Laid-open Patent Publication No. 2008-52115, while reducing a maximum allowable value of printing position displacement.

However, if the maximum allowable value of printing displacement is set to be small, printing displacement is strictly determined for all the sheets. For example, the strict determination is made even for a sheet whose printing appearance is not so much affected by a printing displacement (such as a sheet on which an image not extending across two sheets is printed or a single sheet that forms an innermost double-spread page). As a result, the printing failure rate increases, resulting in an increase in printing cost and a reduction in printing productivity.

On the other hand, if the maximum allowable value of printing displacement is made large to reduce the printing failure rate, a large printing displacement can occur on a sheet on which one half of an image extending across two sheets is printed, resulting in poor printing appearance.

As described above, if the fixed maximum allowable value of printing displacement is applied to the printing displacement determination for all the sheets, a problem is posed that improvement of printing quality and reduction in printing failure rate cannot simultaneously be achieved.

### SUMMARY OF THE INVENTION

The present invention provides a printing apparatus, a printing method, and a storage medium, which are capable of improving the printing quality and at the same time capable of reducing the printing failure rate.

According to a first aspect of this invention, there is provided a printing apparatus comprising a printing unit configured to perform printing on plural sheets based on first image data, a reading unit configured to read plural images printed on the sheets printed by the printing unit and create second image data based on a result of reading the plural images, a detection unit configured to detect, by comparing the first image data and the second image data, an amount of printing displacement on each of the plural printed sheets, a determination unit configured to determine whether the amount of printing displacement on each of the sheets detected by the detection unit falls within an allowable range defined by an allowable value, and a control unit configured, in a case where a saddle-stitching process, in which a plurality of printed sheets are folded into two and stitched together, is specified in printing settings used for the printing performed based on the first image data, to perform control to change the allowable value between a particular sheet on which an image is printed in a peripheral area around a folded sheet portion and a sheet other than the particular sheet.

According to a second aspect of this invention, there is provided a printing method comprising a printing step of performing printing on plural sheets based on first image data, a reading step of reading plural images printed on the sheets printed in said printing step and creating second image data based on a result of the reading, a detection step of detecting, by comparing the first image data and the second image data, an amount of printing displacement on each of the plural printed sheets, a determination step of determining whether the amount of printing displacement on each of the sheets detected in the detection step falls within an allowable range defined by an allowable value, and a control step of, in a case where a saddle-stitching process, in which a plurality of printed sheets are folded into two and stitched together, is specified in printing settings used for the printing performed based on the first image data, performing control to change the allowable value between a particular sheet on which an image is printed in a peripheral area around a folded sheet portion and a sheet other than the particular sheet.

According to a third aspect of this invention, there is provided a storage medium storing a program for executing the control method described in the second aspect.

With this invention, it is possible to inspect defective printing on sheets subjected to a saddle-stitching book-binding process and to improve the printing quality and at the same time to reduce the printing failure rate.

Further features of the present invention will become apparent from the following description of exemplary embodiments with reference to the attached drawings.

### BRIEF DESCRIPTION OF THE DRAWINGS

FIG. 1 is a schematic view showing the construction of a printing apparatus according to embodiments of this invention;

FIG. 2 is a block diagram showing the construction of a printing controller that controls the printing apparatus;

FIG. 3 is a schematic view showing the construction of an operation unit of the printing apparatus;

FIG. 4 is a block diagram showing the construction of an inspection unit of the printing apparatus;

FIGS. 5A and 5B are views showing an extraction correction process performed by an extraction correction unit of the inspection unit;

FIG. 6 is a view showing an example structure of a printer driver setting screen displayed on a monitor of a host computer;

FIG. 7 is a view showing an example structure of a property setting screen in a state where a “Finishing” tab is selected on the property setting screen;

FIGS. 8A and 8B are a flowchart showing a printing control process performed by the printing controller;

FIGS. 9A and 9B are a flowchart showing an inspection process performed by the inspection controller of the inspection unit according to a first embodiment of this invention;

FIG. 10 is a view showing an example display screen of the operation unit on which a printing displacement occurrence notification is displayed;

FIG. 11 is a view showing an example display screen of the operation unit on which an inspection result NG notification is displayed;

FIGS. 12A to 12E are views for explaining a problem of a prior art printing apparatus; and

FIGS. 13A to 13D are a flowchart showing an inspection process performed by the inspection controller according to a second embodiment of this invention.

### DESCRIPTION OF THE EMBODIMENTS

The present invention will now be described in detail below with reference to the drawings showing preferred embodiments thereof.

### First Embodiment

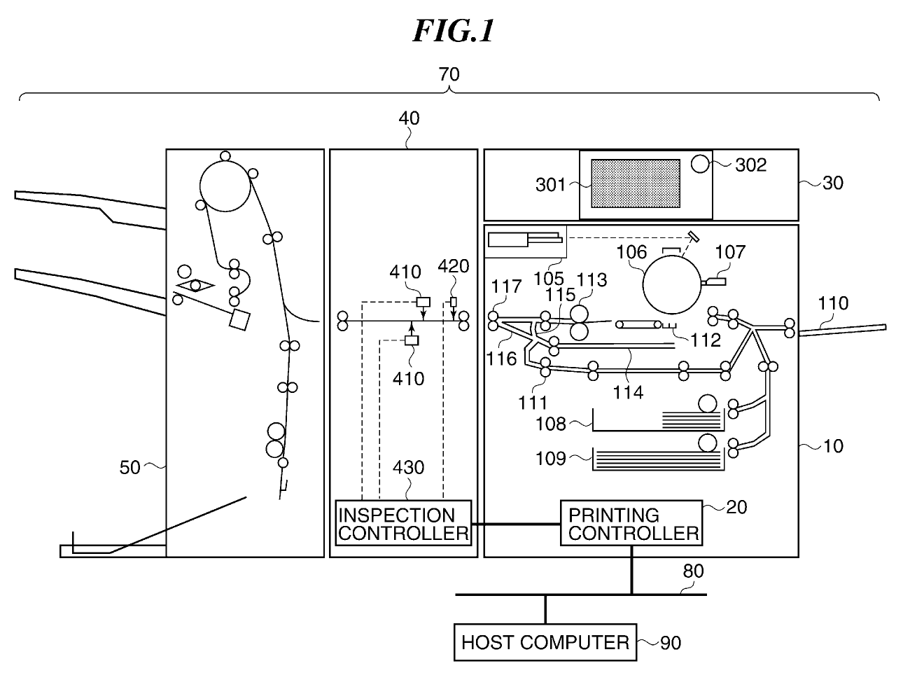

FIG. 1 schematically shows the construction of a printing apparatus according to embodiments of this invention.

As shown in FIG. 1, the printing apparatus 70 is connected to a host computer 90 via a network 80, whereby a printing system is configured. The printing apparatus 70 includes a printer engine 10, operation unit 30, inspection unit 40, and finisher 50, which are controlled by a printing controller 20 of the printing apparatus 70.

In the following, operation of the printing system, especially, operation of the printing apparatus 70, will be described in brief.

The host computer 90 creates a print job from a document of plural pages, which was prepared by an application program, and transmits the created print job to the printing controller 20 via the network 80.

The printing controller 20 creates image data of plural pages by analyzing the print job received from the host computer 90, sequentially converts the image data into image signals, and transmits the image signals to an exposure controller 105 of the printer engine 10. The exposure controller 105 outputs laser light according to the image signals. When the laser light is irradiated onto a photosensitive drum 106, an electrostatic latent image is formed on the drum 106. This image is converted into a developer image using a developer supplied from a developing unit 107. The developer image on the photosensitive drum 106 is transferred by a transfer unit 112 onto a sheet (e.g., a recording sheet) fed from a cassette 108 or 109 or a manual sheet feeder 110 or a double-sided conveyance path 111. The sheet on which the developer image has been transferred is conveyed to a fixing unit 113 where a fixing process is performed on the developer image.

The sheet passing through the fixing unit 113 is guided by a flapper (not shown) from a path 115 to a path 114. When the trailing end of the sheet passes through the path 115, the sheet is switched back and guided from a path 116 to discharge rollers 117, thereby making it possible for the discharge rollers 117 to discharge the sheet from a printer engine 10, with its face on which the developer image has been transferred and fixed being directed downward (i.e., face-down). This is called sheet inverted discharging. With the face-down discharging, sheets can be discharged to and stacked on a discharge tray in a correct page order from the top page.

In the case of printing on a hard sheet (e.g., an OHP sheet) supplied from the manual sheet feeder 110, the sheet on which a developer image has been fixed is not guided to the path 115, but discharged from the discharge rollers 117, with its face on which the developer image has been fixed being directed upward (face-up).

In the case of printing on both sides of a sheet, the sheet having one surface on which a developer image has been fixed is guided from the fixing unit 113 to the paths 115, 114. When the trailing end of the sheet has passed through the path 115, the sheet is switched back and guided by a flapper (not shown) to the double-sided conveyance path 111. Then, a developer image is transferred by the transfer unit 112 onto another surface of the sheet guided to the double-sided conveyance path 111, and the fixing process is performed thereon by the fixing unit 113.

The looped sheet transfer path extending from the transfer unit 112 to the double-sided conveyance path 111 and returning to the transfer unit 112 has a plurality of path sections. These path sections are designed to have appropriate path lengths, roller arrangements, and drive systems such as to be able to convey a plurality of half-sized sheets of A4 or B5 size, if such sheets are disposed in the looped sheet transfer path. Double-sided printed sheets are discharged, with their odd-numbered pages directed downward.

A printed-out product discharged from the discharge roller 117 is conveyed to the inspection unit 40 in which the printed product (printed sheet) is detected by a sensor 420 and image data of both surfaces of the printed-out product is read by an image reader 410. Subsequently, the printed-out product is conveyed to the finisher 50 to perform thereon post-processing such as book-binding or binding or punching.

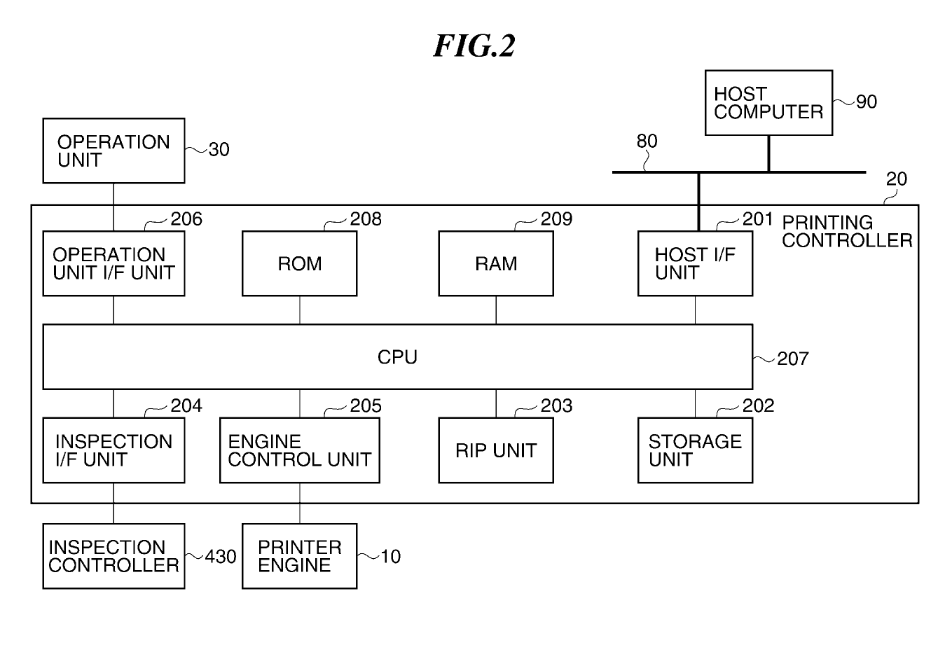

FIG. 2 shows the construction of the printing controller 20 in block diagram.

In FIG. 2, reference numeral 201 denotes a host I/F unit that communicates with the host computer 90 via the network 80. The host I/F unit 201 receives, e.g., a print job transmitted from the host computer 90. In this embodiment, the printing controller 20 is connected to the host computer 90 via the network 80, but this is not limitative. The connection can be established by using a USB interface, a parallel interface, or the like.

Reference numeral 202 denotes a storage unit that stores a received print job, image data, etc. and is implemented by a memory, a hard disk, or the like; 203, a RIP (raster image processor) unit for developing PDL data of a print job into image data; 204, an inspection I/F unit that communicates with an inspection controller 430; and 205, an engine control unit that controls the printer engine 10.

Reference numeral 206 denotes an operation unit I/F unit that communicates with the operation unit 30; and 207, a CPU as an arithmetic unit (processor) for controlling the units 201-206 for smooth operation of the entire printing apparatus.

Reference numeral 208 denotes a nonvolatile memory (hereinafter, referred to as the ROM) implemented by, e.g., a flash memory for storing a program to be executed by the CPU 207; and 209, a volatile memory (hereinafter, referred to as the RAM) such as a DRAM, which is used by the CPU 207 as a system work memory for its operation.

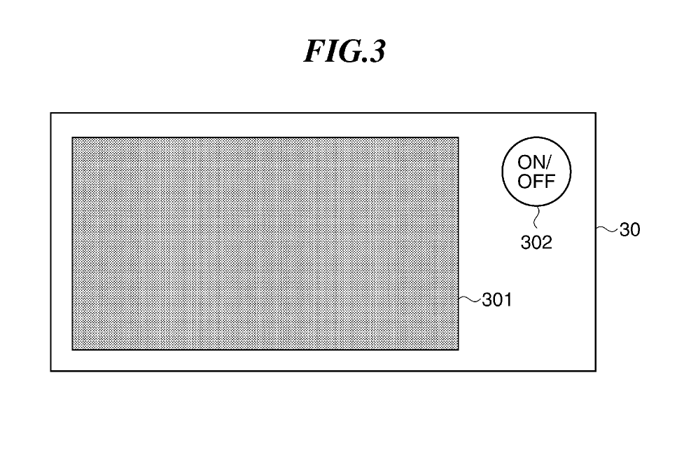

FIG. 3 schematically shows the construction of the operation unit 30.

As shown in FIG. 3, the operation unit 30 includes a touch panel display 301 and a power button 302.

The touch panel display 301 includes an LCD display device onto which a touch panel sheet is affixed, and displays an operation screen. If some area of the displayed screen is depressed, position information about the area is transmitted to the printing controller 20. The power button 302 is used to control the power on/off of the printing apparatus 70 and make a shift to and a return from a power-saving mode.

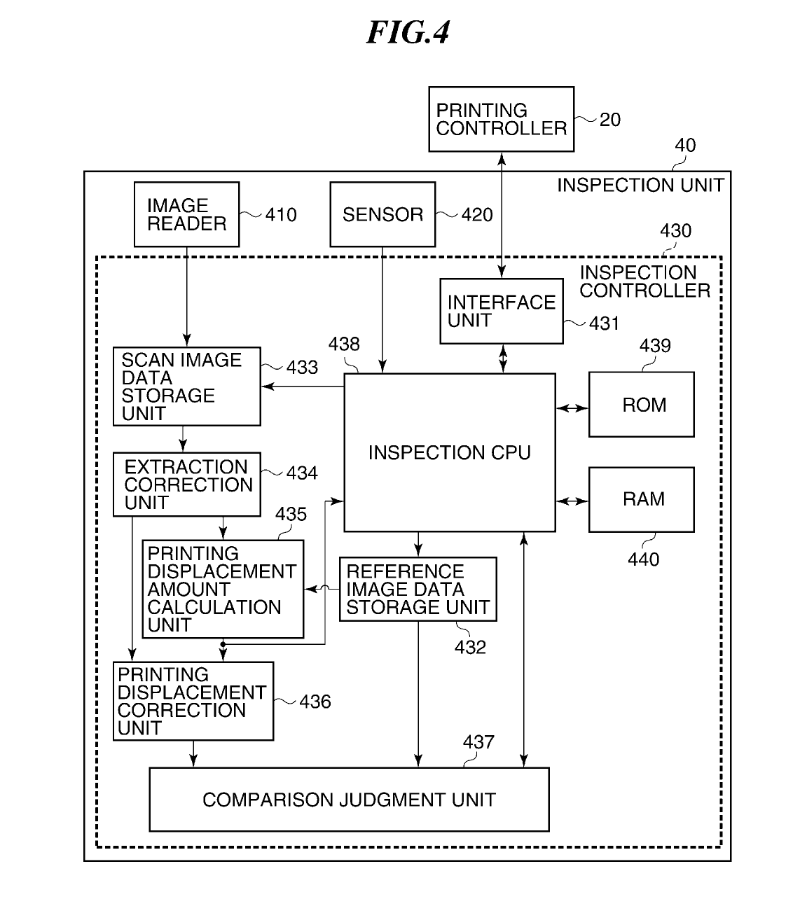

FIG. 4 shows in block diagram the construction of the inspection unit 40.

The inspection unit 40 includes the inspection controller 430 that includes an interface unit 431, a reference image data storage unit 432, a scan image data storage unit 433, an extraction correction unit 434, a printing displacement amount calculation unit 435, a printing displacement correction unit 436, a comparison judgment unit 437, an inspection CPU 438, a ROM 439, and a RAM 440.

The interface unit 431 is for communicating with the printing controller 20. The reference image data storage unit 432 stores reference image data transmitted from the printing controller 20.

The scan image data storage unit 433 stores scan image data read by the image reader 410. The extraction correction unit 434 extracts, from a scan image, a sheet-equivalent scan image portion (a scan image portion corresponding to a sheet), as will be described below.

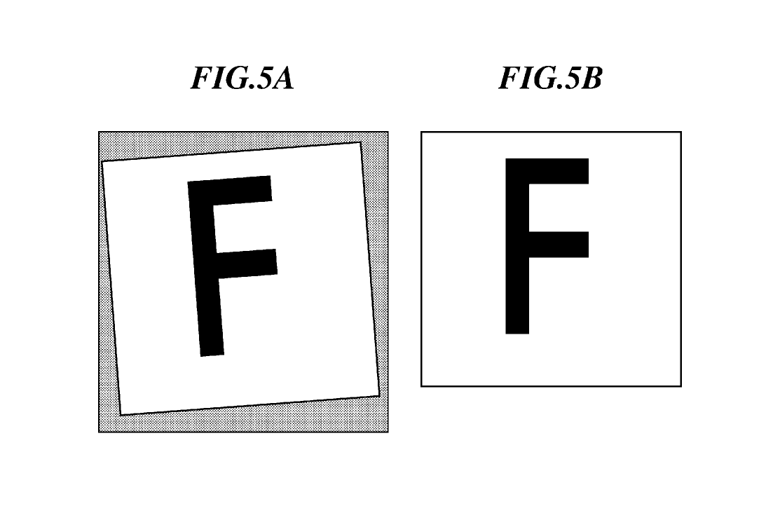

FIGS. 5A and 5B show an extraction correction process performed by the extraction correction unit 434.

As shown in FIG. 5A, a scan image read by the image reader 410 has an area larger than a sheet size for the reason that a sheet can be displaced during being conveyed. To compare the scan image data with reference image data, the extraction correction unit 434 detects a position of the sheet-equivalent scan image portion on the scan image, and extracts the scan image portion from the scan image, as shown in FIG. 5B. At that time, the position of the sheet-equivalent scan image portion on the scan image can easily be detected by using a scan background color (gray in the example shown in FIG. 5A) made different from the color of the sheet.

Referring to FIG. 4, the printing displacement amount calculation unit 435 calculates a relative positional relation between reference image data stored in the reference image data storage unit 432 and scan image data extracted by the extraction correction unit 434. The printing displacement amount calculation unit 435 calculates an evaluation numerical value that represents a coincidence degree between the reference image data and the scan image data, while changing the positional relation between the reference image data and the scan image data, and detects, as an amount of printing displacement, an amount of change in positional relation corresponding to an evaluation numerical value that provides an optimum coincidence degree.

To reduce an amount of calculation, the printing displacement amount calculation unit 435 does not calculate the evaluation numerical value based on all of vertical and lateral pixel rows in image data, but calculates the evaluation numerical value based on pixel rows selected from among the vertical and lateral pixel rows. As the evaluation numerical value, there can be used correlation coefficients, the sum of absolute values of differences between corresponding pixels, the sum of squares of differences between corresponding pixels, or the like. A method for calculating the amount of printing displacement by the printing displacement amount calculation unit 435 is not limitative and known from e.g., Japanese Laid-open Patent Publication No. H 7-249122, and therefore a description of the calculating method is omitted herein.

The printing displacement correction unit 436 corrects the scan image data extracted by the extraction correction unit 434 by using the amount of displacement calculated by the printing displacement amount calculation unit 435. The comparison judgment unit 437 compares the scan image data corrected by the printing displacement correction unit 436 with the reference image data stored in the reference image data storage unit 432, thereby determining a difference between the corrected scan image data and the reference image data. A method for image comparison determination by the comparison judgment unit 437 is not limitative and known from e.g., Japanese Patent Publication No. H 1-47823, and therefore a description of the image comparison determination method is omitted.

The inspection CPU 438 is an arithmetic device (processor) that controls respective parts of the inspection unit 40 such that the inspection unit 40 smoothly operates. The inspection CPU 438 determines whether an amount of printing displacement detected by the printing displacement amount calculation unit 435 falls within an allowable range determined by an allowable value of printing displacement (described later) or an allowable value of book-binding printing displacement (described later).

A nonvolatile memory (hereinafter, referred to as the ROM) 439 stores a program for the inspection CPU 438 and is implemented by, e.g., a flash memory. A volatile memory (hereinafter, referred to as the RAM) 440, which is implemented by, e.g., a DRAM, is a system work memory used by the inspection CPU 438 for its operation.

The units 434 to 437 of the inspection controller 430 can be realized by a program stored in and read from the ROM 439 and executed by the inspection CPU 438 or can be realized by hardware. The reference image data storage unit 432, the scan image data storage unit 433, and the RAM 440 can be configured by the same storage unit or configured by different storage units.

In the following, a description will be given of operation of the host computer 90.

The host computer 90 uses a printer driver as a means for supplying a proof output from a printing application running on the host computer 90 to a print device such as the printing apparatus 70 or for outputting a final product.

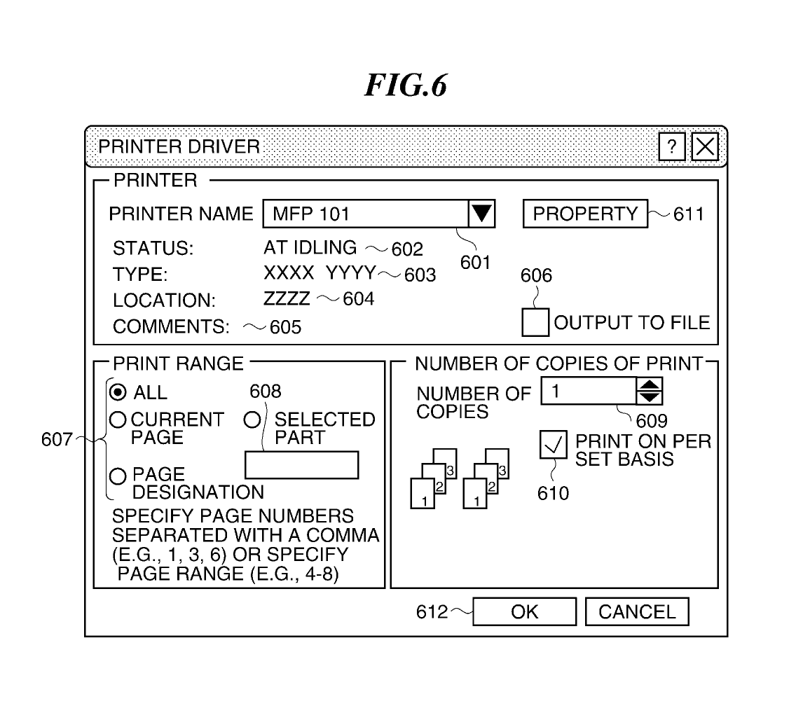

FIG. 6 shows an example structure of a printer driver setting screen displayed on a monitor of the host computer 90.

The printer driver setting screen shown in FIG. 6 is usually displayed on the monitor when a printing menu of the printing application is selected by an operator to give an instruction to perform printing to a print device such as the printing apparatus 70 from the host computer 90.

A print device to be used is selected by the operator from a “Printer Name” pull down list box 601 in a “Printer” field of the setting screen. A status of the selected print device is displayed in a “Status” field 602, a type of a printer driver is displayed in a “Type” field 603, a location of the print device is displayed in a “Location” field 604, and print device manager's comments are displayed in a “Comments” field 605.

To output print data to a file without printing the print data, an “Output to File” check box 606 is marked and selected.

In a “Print Range” field, one or more pages to be printed are specified by selecting any of “All,” “Current Page,” “Selected Page” and “Page Designation” options by clicking a corresponding one of radio buttons 607. If the “Page Designation” option is selected, one or more page numbers to be printed are input into an edit box 608.

In a “Number of Copies of Print” field, the number of copies to be printed is input into a “Number of Copies” spin box 609. To print a plural number of copies not on a per page basis but on a per set basis, a “Print on a per Set Basis” check box 610 is marked and selected.

By depressing a “Property” button 611, further detailed print attributes can be set.

After completion of the settings on the printer driver setting screen, print data can be transmitted to the print device or can be output to a file by depressing an “OK” button 612. Printing or file output can be stopped by depressing a “Cancel” button 613.

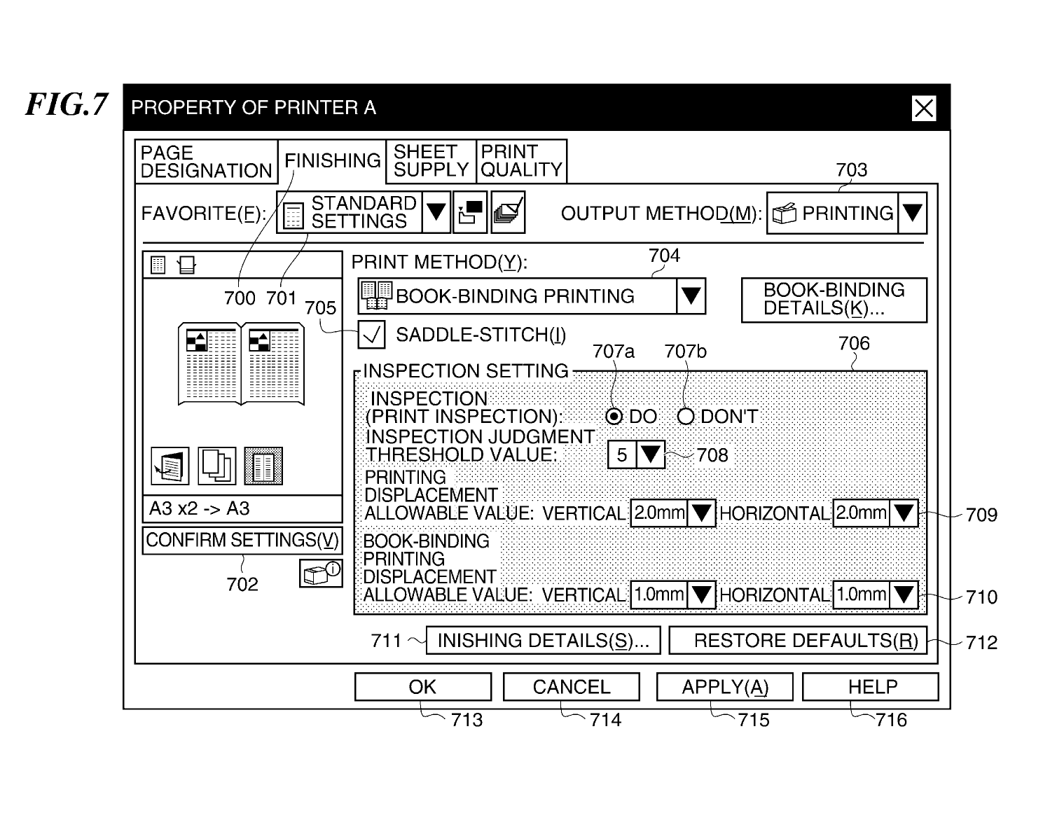

FIG. 7 shows an example structure of a property setting screen associated with a printer driver finishing process. The screen shown in FIG. 7 is displayed when a “Finishing” tab 700 is selected on the property setting screen.

Referring to FIG. 7, in a “Favorite” pull down list box 701, a desired page setting mode is selected from among predetermined page setting modes. By using two buttons disposed on the right side of the box 701, selection items of “Favorite” can be added and edited.

By depressing a “Confirm Settings” button 702, contents set on the property setting screen can be displayed in a list. The contents of settings are reflected to page images, which are displayed in a screen area located above the button 702.

In an “Output Method” pull down list box 703, an output method is specified according to which normal printing or secure printing is performed by the print device or data is stored into a hard disk of the print device or editing and preview are performed by the print device.

In a “Print Method” pull down list box 704, any of a “One-sided Printing,” “Double-sided Printing,” and “Book-binding Printing” options is selected as a printing method. If the “Book-binding Printing” option is selected in the pull down list box 704, a “Saddle-stitch” check box 705 becomes effective. By checking the check box 705, it is possible to designate a saddle-stitching book-binding process (where a plurality of sheets printed at their same surfaces with images of plural pages are stacked one upon another, folded into two, and stitched together).

In an “Inspection Setting” field 706, it is possible to make settings for inspection. If a “Do” radio button 707a in an “Inspection (Print Inspection)” field is checked, inspection will be performed (associated images will be inspected). If a “Don't” radio button 707b is checked, inspection will not be performed (images will not be inspected). If the “Do” button 707a is checked, an “Inspection Judgment Threshold Value” field 708, “Printing displacement Allowable Value” field 709, and “Book-binding Printing displacement Allowable Value” field 710 become effective.

In the “Inspection Judgment Threshold Value” field 708, there is provided a pull down menu for selecting any of levels 1 to 10. The inspection can be performed more strictly with increase in level value. Although it is assumed in this embodiment that threshold values respectively corresponding to the levels 1 to 10 are set in advance, a threshold value can be input into the field 708.

The “Printing displacement Allowable Value” field 709 is for setting a printing displacement allowable value that represents what degree of positional displacement is allowed at printing. A vertical allowable value and a horizontal allowable value can be set independently of each other.

The “Book-binding Printing displacement Allowable Value” field 710 becomes effective, if the “Book-binding Printing” option is selected in the “Print Method” pull down list box 704 and the “Saddle-stitch” check box 705 is checked. The field 710 is for setting a book-binding printing displacement allowable value that represents what degree of positional displacement is allowed at printing of particular pages (described later). Vertical and horizontal allowable values can be set independently of each other. The printing displacement allowable value set in the filed 709 is used as a printing displacement allowable value for pages other than the particular pages. It is possible to control the book-binding printing displacement allowable value settable in the field 710 so as not to exceed the printing displacement allowable value set in the field 709.

By depressing a “Finishing Details” button 711, a further detailed finishing method can be set. By depressing a “Restore Defaults” button 712, the settings can be restored to default settings.

By depressing an “OK” button 713 after completion of the settings on the printer driver property setting screen, print attributes can be reflected in actual printing. To abort the settings on the property setting screen, a “Cancel” button 714 is depressed.

Print attributes set on the property setting screen can be finally determined by depressing an “Apply” button 715. The settings on the property setting screen can be continued, as needed, even after the print attributes are finally determined.

A “Help” button 716 is for displaying a help screen for the property setting screen.

When a printing instruction is given from the host computer 90, a print job that includes print settings set on the property setting screen shown in FIG. 7 is created by the printer driver of the host computer 90 and transmitted to the printing controller 20 of the printing apparatus 70. The print settings include print information (such as the number of pages of a document to be printed, sheet size, one-sided/double-sided printing, and finishing mode) and inspection information (such as inspection execution mode/inspection off mode, inspection judgment threshold value, printing displacement allowable value, and book-binding printing displacement allowable value). It is assumed that any of threshold values respectively corresponding to the levels 1 to 10 is transmitted as the inspection judgment threshold value to the printing controller 20.

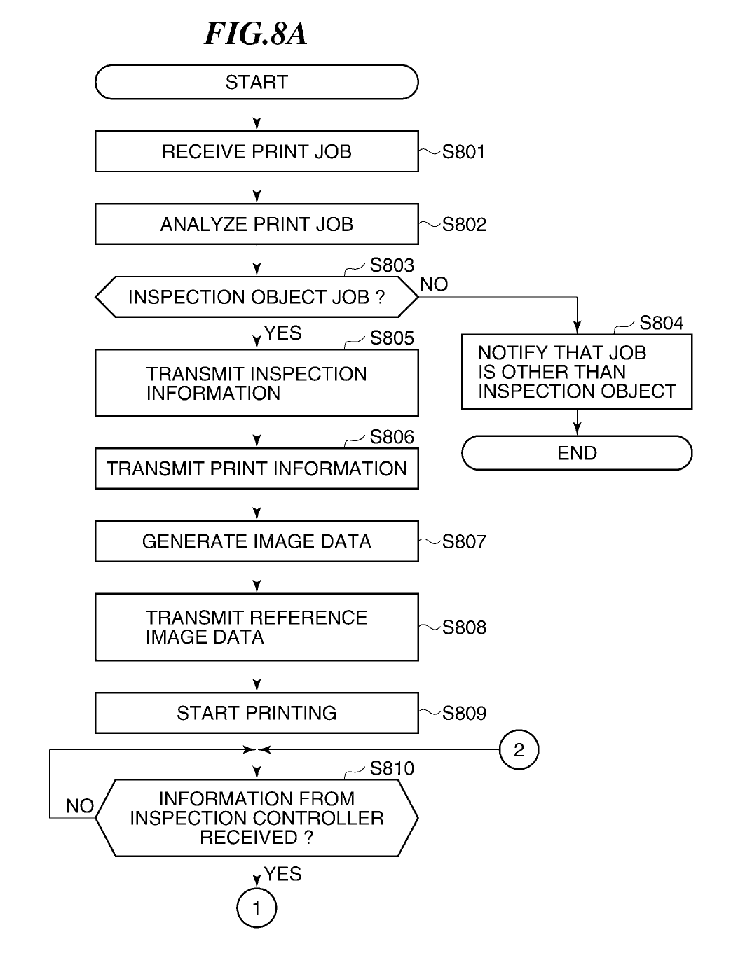

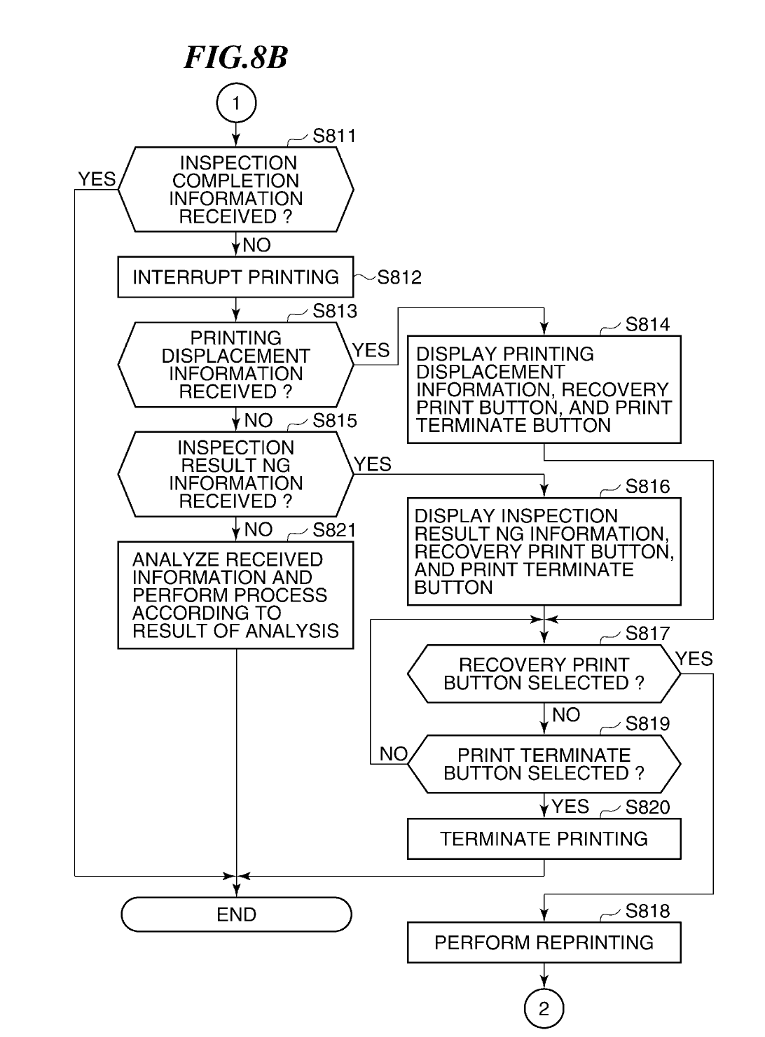

In the following, a description will be given of operation of the printing controller 20 with reference to FIGS. 8A and 8B.

FIGS. 8A and 8B show in flowchart a printing control process performed by the printing controller 20. The printing control process is performed by the CPU 207 of the printing controller 20 by reading and executing a program stored in, e.g., the ROM 208.

When receiving a print job containing plural pages from the host computer 90 via the host I/F unit 201, the CPU 207 stores the received print job into the storage unit 202 (S801), and analyzes the received print job (S802).

Based on a result of the analysis in S802, the CPU 207 determines whether the received print job is an inspection object (i.e., whether the inspection execution mode is set for the received print job) (S803). If the answer to S803 is No, the CPU 207 notifies the inspection controller 430 that the received job is other than an inspection object (i.e., the inspection off mode is set for the received job) (S804), whereupon the present process is completed and a normal print job process (not shown) is executed.

On the other hand, if it is determined in 5803 that the inspection execution mode is set (i.e., if Yes to S803), the CPU 207 transmits, to the inspection controller 430, inspection information such as inspection execution mode, inspection judgment threshold value, printing displacement allowable value, and book-binding printing displacement allowable value (S805), and transmits, to the inspection controller 430, print information such as the number of pages of a document to be printed, sheet size, one-sided/double-sided printing, and finishing mode (S806).

Next, the CPU 207 causes the RIP unit 203 to develop PDL data contained in the print job to thereby generate image data of plural pages (first image data), and stores the image data into the storage unit 202 (S807).

Next, the CPU 207 transmits, as reference image data, the image data generated in S807 to the inspection controller 430 (S808), and transmits the image data to the printer engine 10 via the engine control unit 205 to thereby start printing (S809).

Then, the CPU 207 waits for reception of information from the inspection controller 430 (S810). When receiving information from the controller 430 (i.e., if Yes to S810), the CPU 207 determines whether the received information represents the completion of inspection (S811). When determining that the “inspection completion” information is received (i.e., if Yes to S811), the present process is completed. On the other hand, when determining that the received information is other than the “inspection completion” information (i.e., if No to S811), the CPU 207 performs control to temporarily stop the printing in order to wait for reception of an operator's instruction (S812).

Next, the CPU 207 determines whether the information received from the inspection controller 430 is printing displacement information (S813). If it is determined that printing displacement information is received (i.e., if Yes to S813), the flow proceeds to S814.

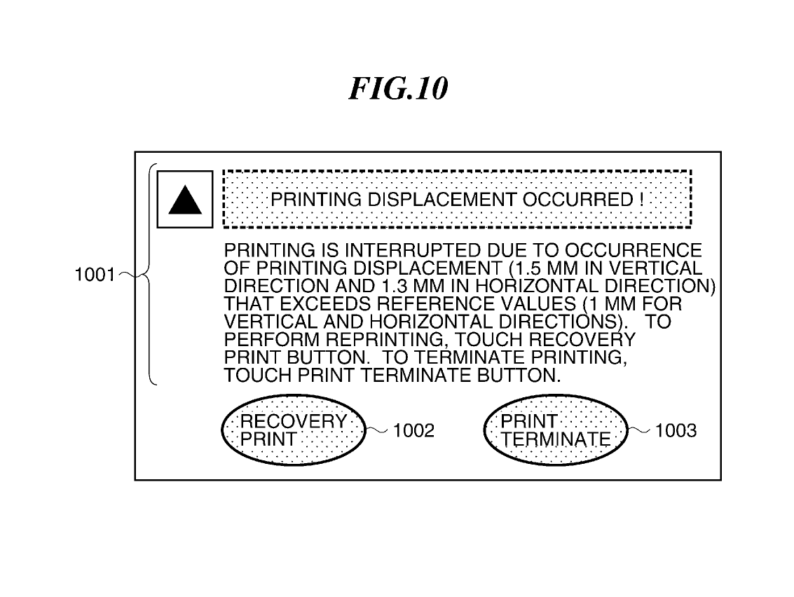

In S814, the CPU 207 displays a screen, shown by way of example in FIG. 10, on the touch panel display 301 of the operation unit 30. On the screen, there are displayed a message 1001 indicating that a printing displacement has occurred, a “Recovery Print” button 1002, and a “Print Terminate” button 1003. Then, the flow proceeds to S817.

On the other hand, if it is determined in S813 that the information received from the inspection controller 430 is not printing displacement information (i.e., if No to S813), the flow proceeds to S815.

In S815, the CPU 207 determines whether the information received from the inspection controller 430 is “inspection result NG” information. If it is determined that the “inspection result NG” information is received (i.e., if Yes to S815), the flow proceeds to S816.

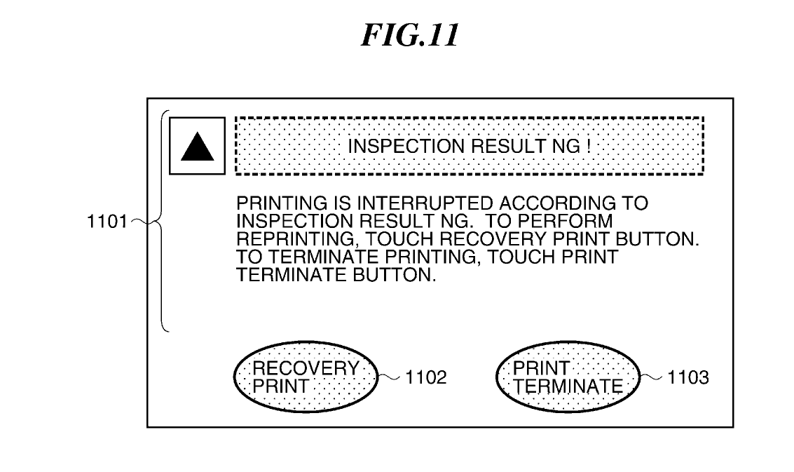

In S816, the CPU 207 displays a screen, shown by way of example in FIG. 11, on the touch panel display 301. On the screen, a message 1101 indicating that an inspection result is NG (printing failure), a “Recovery Print” button 1102, and a “Print Terminate” button 1103 are displayed. Then, the flow proceeds to 5817.

In step S817, the CPU 207 waits for the “Recovery Print” button 1002 shown in FIG. 10 or the “Recovery Print” button 1102 shown in FIG. 11 being selectively operated (touched).

If it is determined that the “Recovery Print” button 1002 or 1102 is selectively operated (i.e., if Yes to S817), the flow proceeds to S818.

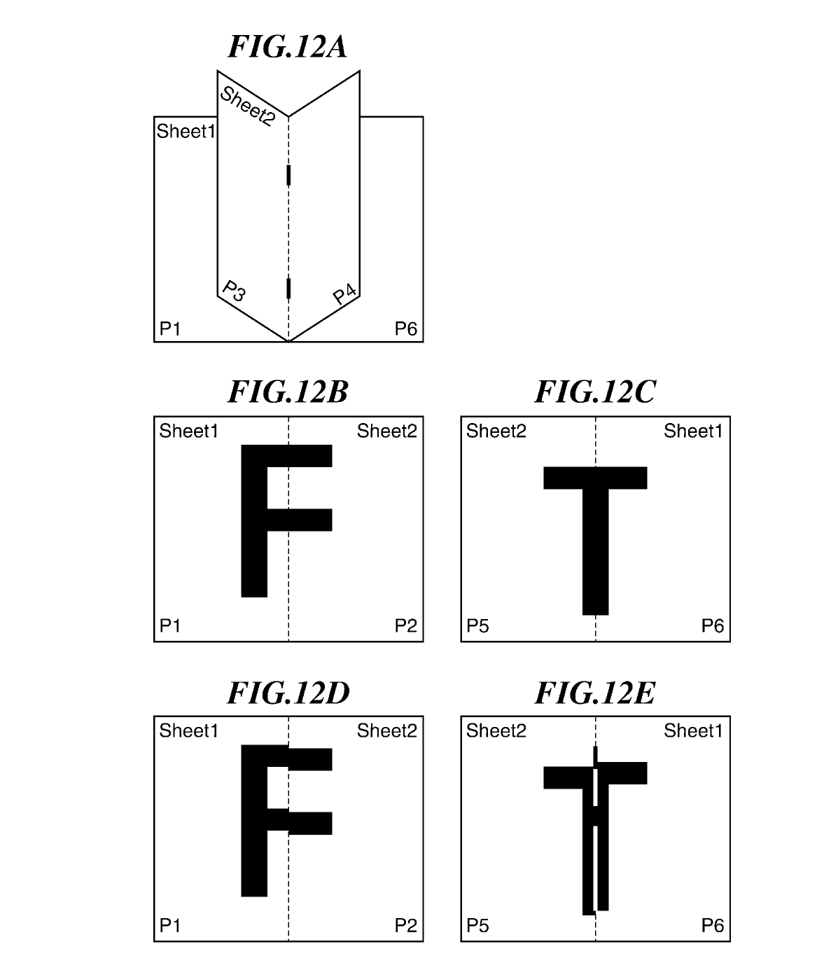

In S818, the CPU 207 performs control to perform reprinting according to one or more page numbers indicated in the information received from the inspection controller 430 as those where printing displacement or inspection result NG has occurred. In a case, for example, that printing displacement or inspection result NG has occurred on the second and fifth pages of a six-page document such as that shown in FIG. 12A, the CPU 207 performs control to perform reprinting to print the second and fifth pages on one surface of a sheet and print the third and fourth pages on another surface of the sheet. Then, the flow returns to S810.

Although not shown in FIGS. 8A and 8B, the CPU 207 restarts the interrupted printing from the required page after the reprinting in S818 is completed. In a case, for example, that the printing apparatus has the inspection unit 40 provided with a retreat tray or the like (not shown) and configured to be able to discharge reprinted sheets while inserting the reprinted sheets in the original order, the printing is restarted from the interrupted page in S812 after completion of the reprinting. On the other hand, in the case of the printing apparatus not having a retreat tray or the like and configured unable to insert reprinted sheets in the original order, the printing is restarted from a page that follows the reprinted pages after completion of the reprinting.

When determining in step S817 that none of the “Recovery Print” buttons 1002, 1102 is selectively operated, the CPU 207 determines whether either the “Print Terminate” button 1003 shown in FIG. 10 or the “Print Terminate” button 1103 shown in FIG. 11 is selectively operated (step S819). If the answer to step S819 is No, the flow returns to step S817. On the other hand, when determining in S819 that the “Print Terminate” button 1003 or 1103 is selectively operated, the CPU 207 terminates the printing (S820), and the present process is completed.

When determining in S815 that the information received from the inspection controller 430 is other than the “inspection result NG” information, the CPU 207 analyzes the received information and performs a process according to the content of the received information (S821). Then, the present process is completed.

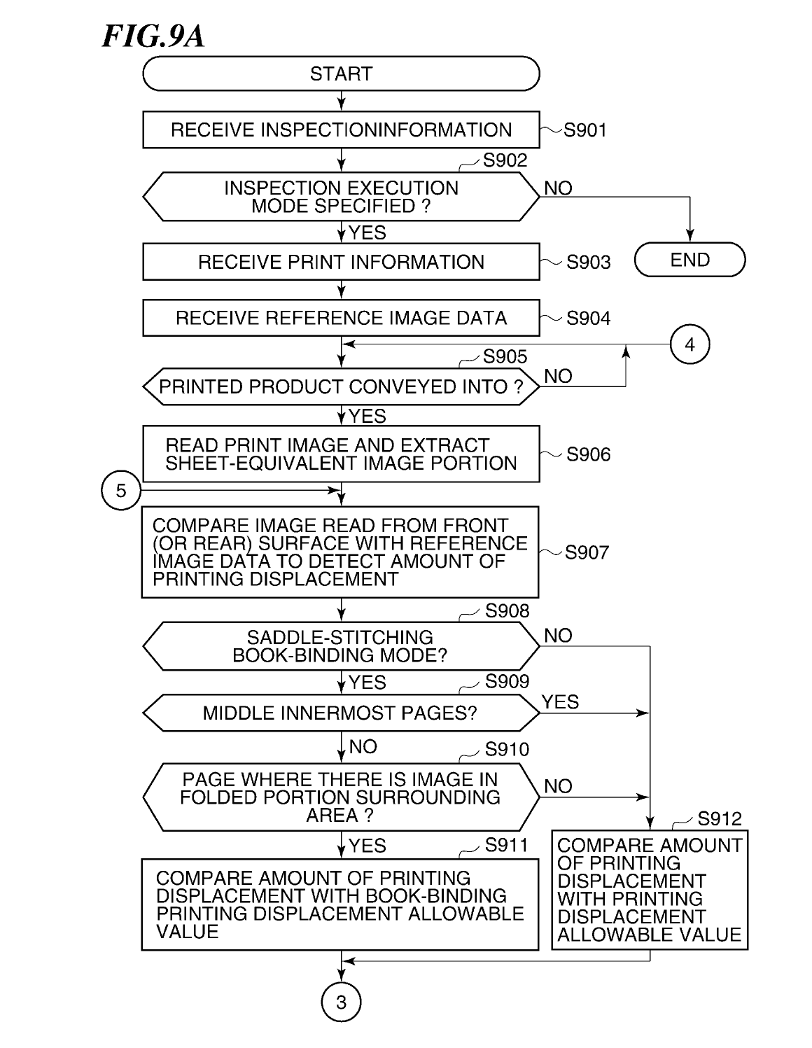

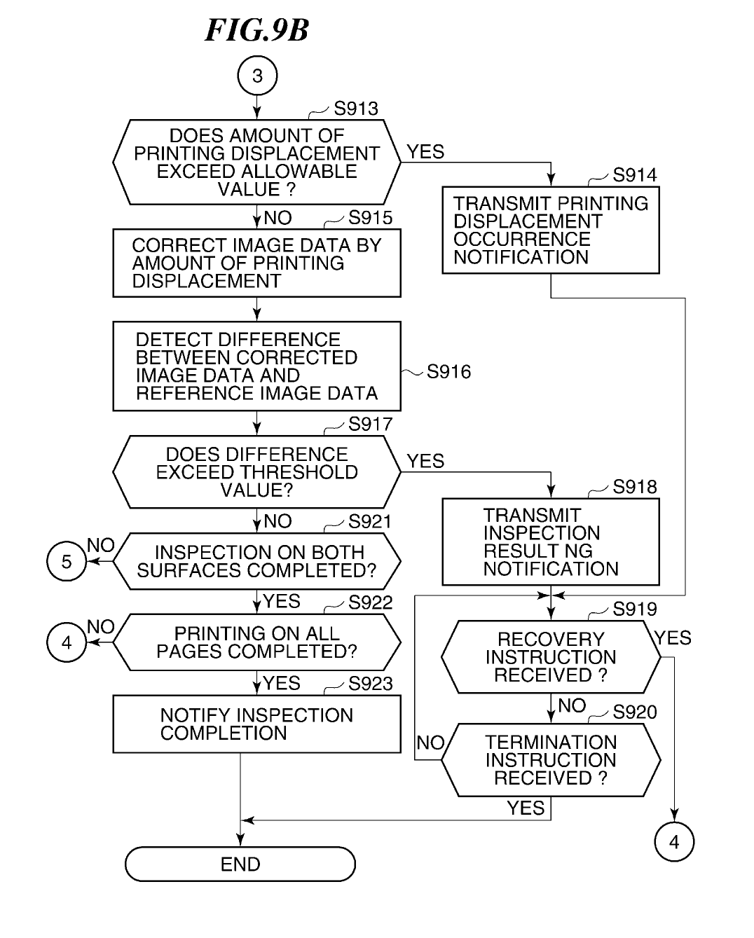

In the following, a description will be given of operation of the inspection controller 430 with reference to FIGS. 9A and 9B.

FIGS. 9A and 9B show in flowchart an inspection process performed by the inspection controller 430. The inspection process is performed by the inspection CPU 438 of the inspection controller 430 by reading and executing a program stored in the ROM 439 or the like.

In S901, the inspection CPU 438 receives, from the printing controller 20 via the interface unit 431, inspection information such as inspection execution mode/inspection off mode, inspection judgment threshold value, printing displacement allowable value, and book-binding printing displacement allowable value.

Next, the inspection CPU 438 analyzes the received inspection information and determines whether the inspection execution mode is specified in the received information (S902). If the answer to S902 is No, the present process is completed. On the other hand, if it is determined in S902 that the inspection execution mode is specified in the inspection information (i.e., if Yes to S902), the flow proceeds to S903.

In S903, the inspection CPU 438 receives, from the printing controller 20, print information such as the number of pages of a document to be printed, sheet size, one-sided/double-sided printing, and finishing mode.

In S904, the inspection CPU 438 receives reference image data from the printing controller 20 and stores it into the reference image data storage unit 432.

In S905, the inspection CPU 438 waits for the sensor 420 to detect that a printed product is conveyed into the inspection unit 40. If it is determined that a printed product is conveyed into the inspection unit 40 (i.e., if Yes to S905), the flow proceeds to S906.

In S906, the inspection CPU 438 operates the image reader 410 to scan images of both surfaces of the printed product (sheet) and generate image data, and stores the image data into the scan image data storage unit 433. Further, the inspection CPU 438 operates the extraction correction unit 434 to detect a position of the sheet-equivalent scan image portion on the scan image from the scan image data and extract data of the scan image portion to generate scan image data (second image data). In the case of double-sided printing, image data of the sheet-equivalent scan image portion is extracted from the scan image data of each of the front and rear surfaces of the sheet.

Then, the inspection CPU 438 inputs the scan image data of the front or rear surface extracted in S906 (hereinafter, referred to as the current scan image data) and the reference image data stored in the reference image data storage unit 432 into the printing displacement amount calculation unit 435, and causes the calculation unit 435 to detect an amount of printing displacement (S907).

Next, based on the content of finishing mode set in the print information received in S903, the inspection CPU 438 determines whether the saddle-stitching book-binding mode is specified for the current scan image data (S908). If the answer to S908 is Yes, the flow proceeds to S909.

In S909, the inspection CPU 438 determines whether the current scan image data corresponds to middle innermost pages based on the number of pages of document specified in the received print information. To this end, the inspection CPU 438 is configured to be able to determine the page layout and the printing order in the printing apparatus 70 based on the received print information and to determine, among printed products conveyed into the inspection unit 40, which surface of which printed product corresponds to the middle innermost pages. The term “middle innermost pages” refers to left and right side pages of one printed product disposed at the innermost side among printed products subjected to the saddle-stitching book-binding process. For example, in the case of a six-page document shown in FIG. 12A, the third and fourth pages of the document correspond to the middle innermost pages.

If it is determined in S909 that the scan image data does not correspond to the middle innermost pages (i.e., if No to S909), the flow proceeds to S910. In S910, the inspection CPU 438 determines whether the inspection object page is a page where there is an image in a folded portion surrounding area (i.e., a peripheral area around a folded portion where sheets are folded into two in the saddle-stitching book-binding process), while referring to reference image data for the inspection object page. It is assumed here that the term “folded portion surrounding area” refers to an area having a width corresponding to the book-binding printing displacement allowable value (specified in the inspection information received in S901) around the folded portion.

When determining in S910 that the inspection object page is a page where there is an image in the folded portion surrounding area, the inspection CPU 438 causes the printing displacement correction unit 436 to compare the amount of printing displacement detected in S907 with the book-binding printing displacement allowable value specified in the inspection information (S911). Specifically, the book-binding printing displacement allowable value is used as an allowable value.

If the saddle-stitching book-binding mode is not specified in the received print information (i.e., if No to S908), or if the current scan image data corresponds to the middle innermost pages (i.e., if Yes to S909), or if the inspection object page is a page where there is no image in the folded portion surrounding area (i.e., if No to S910), the flow proceeds to S912.

In S912, the inspection CPU 438 causes the printing displacement correction unit 436 to compare the amount of printing displacement detected in S907 with the printing displacement allowable value specified in the inspection information (S912). Specifically, the printing displacement allowable value is used as an allowable value.

As described above, if the saddle-stitching book-binding process is specified in the print settings, the inspection CPU 438 performs control to change the allowable value between particular pages and the other pages in S908 to S912. After completion of the processing in S911 or S912, the flow proceeds to S913.

In S913, the inspection CPU 438 determines whether the amount of printing displacement exceeds the allowable value (first determination) based on a result of the comparison in S911 or S912.

If it is determined in S913 that the amount of printing displacement exceeds the allowable value (i.e., if the amount of printing displacement falls outside the allowable range), the flow proceeds to S914.

In S914, the inspection CPU 438 transmits to the printing controller 20 a printing displacement occurrence notification including information that indicates a page number where the printing displacement has occurred. In accordance with the notification, the printing is interrupted (first print control). Then, the flow proceeds to S919.

On the other hand, if it is determined in S913 that the amount of printing displacement does not exceed the allowable value (i.e., if the amount of printing displacement falls within the allowable range), the flow proceeds to S915.

In S915, the inspection CPU 438 causes the printing displacement correction unit 436 to perform a correction to shift the current scan image data by the amount of printing displacement to thereby generate corrected image data (third image data).

Then, the inspection CPU 438 causes the comparison judgment unit 437 to compare the corrected image data generated in S915 with the reference image data to detect a difference therebetween (S916). Then, the comparison judgment unit 437 compares the difference detected in S916 with the inspection judgment threshold value specified in the inspection information received in S901 to determine whether the difference exceeds the threshold value (S917). The threshold value is set to a value that makes it possible to determine the presence/absence of a printing failure such as printing smear, blur, or stain.

If it is determined that the difference exceeds the threshold value (i.e., if Yes to S917), the flow proceeds to S918.

In S918, the inspection CPU 438 transmits to the printing controller 20 a notification of inspection result NG and information indicating the page number where the inspection result NG has occurred, determining that a printing failure such as printing smear, blur, or stain has occurred. In accordance with this notification, the printing is interrupted and the flow proceeds to S919.

When determining that the difference does not exceed the threshold value (i.e., if No to S917), the inspection CPU 438 determines whether the inspection on both the front and rear surfaces is completed (S921). If the answer to S921 is No, the flow returns to S907 where scan image data about another surface is processed.

When determining that the inspection on both surfaces is completed (i.e., if Yes to S921), the inspection CPU 438 compares the number of pages specified in the print information received in S903 with the number of inspected pages to determine whether the printing on all the pages is completed (S922). If there is one or more pages to be reprinted, the above determination is performed for all the pages including reprinted pages.

If it is determined that the printing on all the pages is not completed (i.e., if No to S922), the flow returns to S905. On the other hand, if it is determined that the printing on all the pages is completed (i.e., if Yes to S922), the inspection CPU 438 notifies the printing controller 20 of inspection completion (S923) and completes the present process.

After transmitting the printing displacement occurrence notification to the printing controller 20 in S914 or after transmitting the inspection result NG notification to the controller 20 in S918, the inspection CPU 438 waits for reception of a recovery instruction or a termination instruction from the printing controller 20 (S919 or S920).

If the recovery instruction is received (i.e., if Yes to S919), the flow returns to S905. If the termination instruction is received (i.e., if Yes to S920), the present process is completed.

In a case that the inspection unit 40 has a retreat tray (not shown), the printing apparatus reprints one or more printed products on each of which a printing displacement or an inspection result NG has occurred. The inspection unit 40 discards the printed products on which a printing displacement or an inspection result NG has occurred to an NG tray, retreats printed products of subsequent pages, which have been printed until that time, to the retreat tray, and waits for any of the reprinted products being conveyed into the inspection unit 40. When determining that a printing displacement or an inspection result NG has not occurred on the conveyed reprinted product, the inspection unit 40 performs control to discharge the reprinted product, while inserting the reprinted product in the original order.

On the other hand, in a case that the inspection unit 40 is not provided with a retreat tray, the printing apparatus reprints printed products on which a printing displacement or an inspection result NG has occurred, and also reprints printed products of subsequent pages having been printed until that time. The inspection unit 40 discards the printed products on which a printing displacement or an inspection result NG has occurred to the NG tray, also discards printed products of subsequent pages having been printed until that time, and awaits for any of the reprinted products being conveyed into the inspection unit 40.

As described above, according to the first embodiment, it is possible to change the printing displacement allowable value for each sheet, which will be subjected to the saddle-stitching book-binding process, according to whether the sheet is a sheet that constitutes middle innermost pages (e.g., the third and fourth pages of the six page document shown in FIG. 12A). Accordingly, it is possible to improve the printing quality and at the same time reduce the printing failure occurrence rate in the printing apparatus, which is capable of inspecting defective printing of sheets to be subjected to the saddle-stitching book-binding process.

### Second Embodiment

Next, a second embodiment of this invention will be described. Since the second embodiment is basically substantially the same as the first embodiment, a description will be given of only points different from the first embodiment.

The inspection unit 40 of the first embodiment is configured to inspect an amount of printing displacement in each of sheets printed by the printing apparatus 70. Accordingly, the inspection result NG is not caused unless the amount of printing displacement in each sheet exceeds the allowable value. Even in a case that the inspection result NG is not caused, if printing displacements in a pair of sheets that constitute double-spread pages are opposite in direction from each other (e.g., the printing displacement in one of sheets is upward, whereas the printing displacement in another sheet is downward), the amounts of printing displacements in both the sheets are added together, and therefore an amount of relative printing displacement becomes large.

Thus, the inspection unit 40 of the second embodiment is configured to inspect whether an amount of relative printing displacement in a pair of sheets constituting double-spread pages exceeds an allowable value. Since the printing apparatus of the second embodiment is substantially the same as that of the first embodiment except for operation of the inspection controller 430, a description will be given below of only the operation of the inspection controller 430.

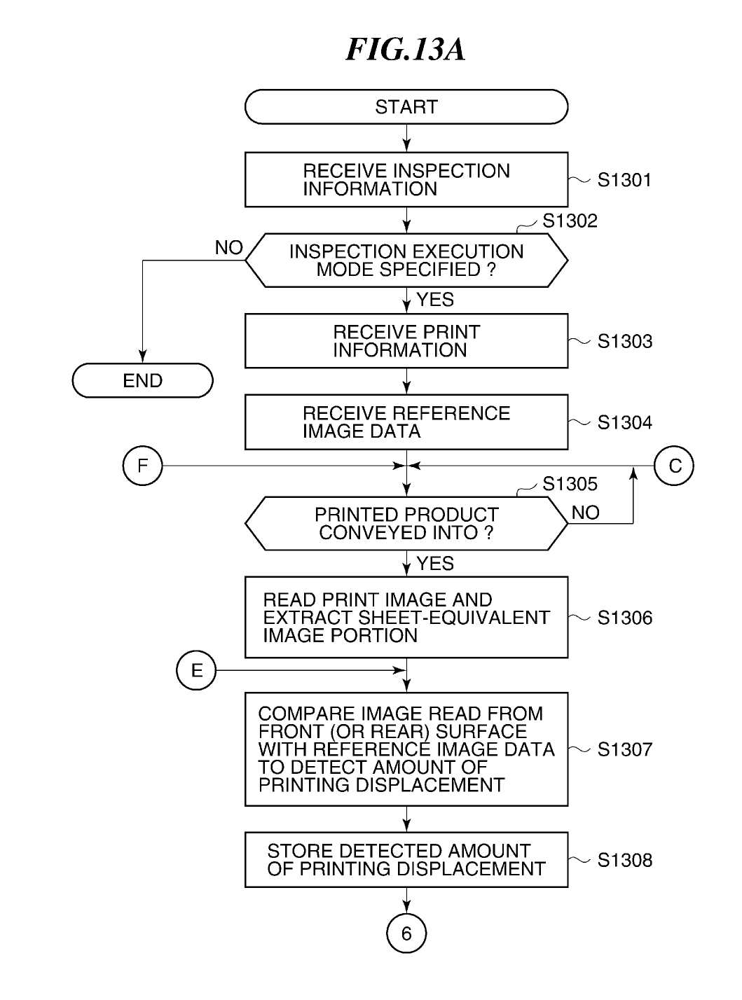

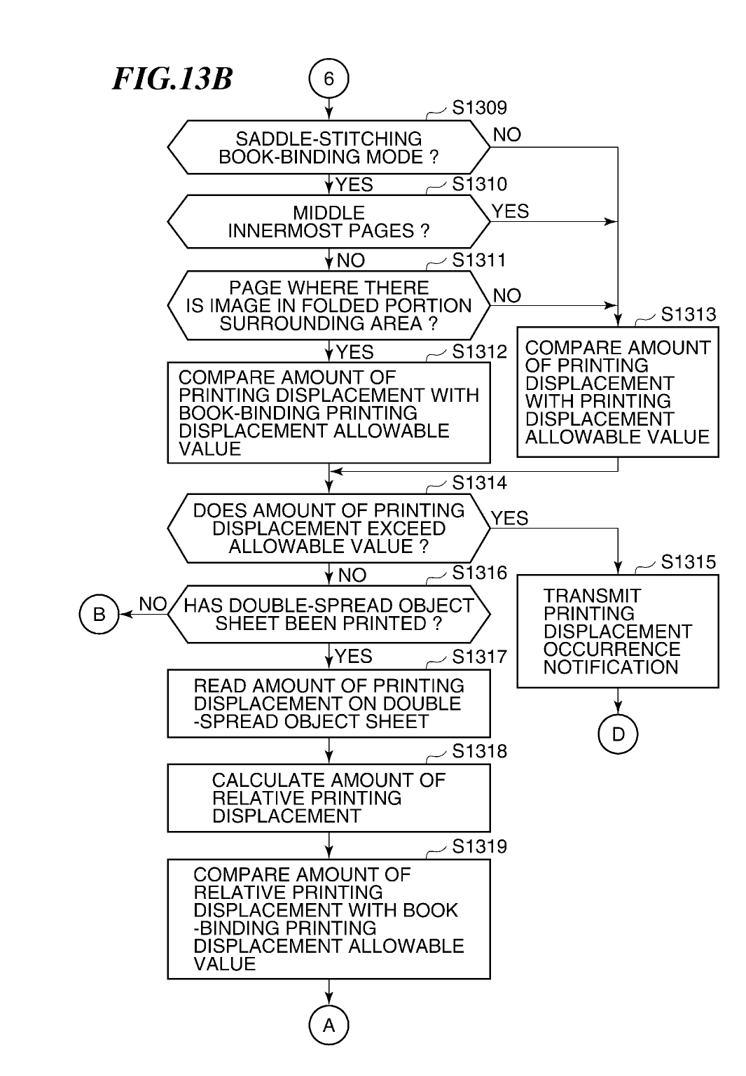

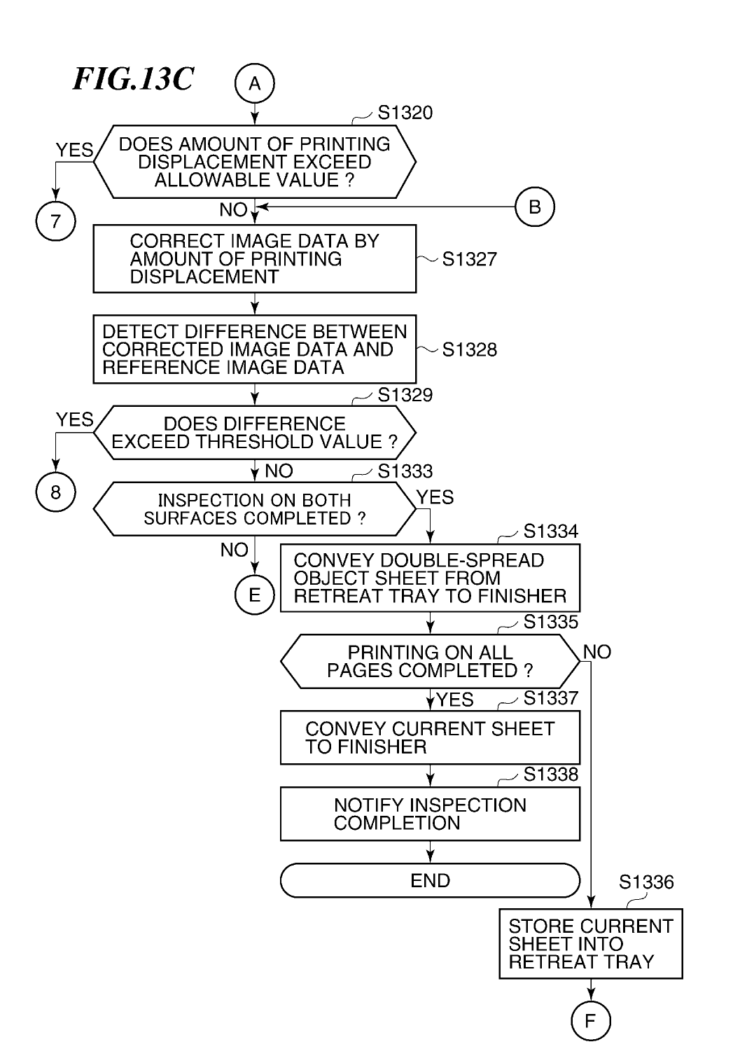

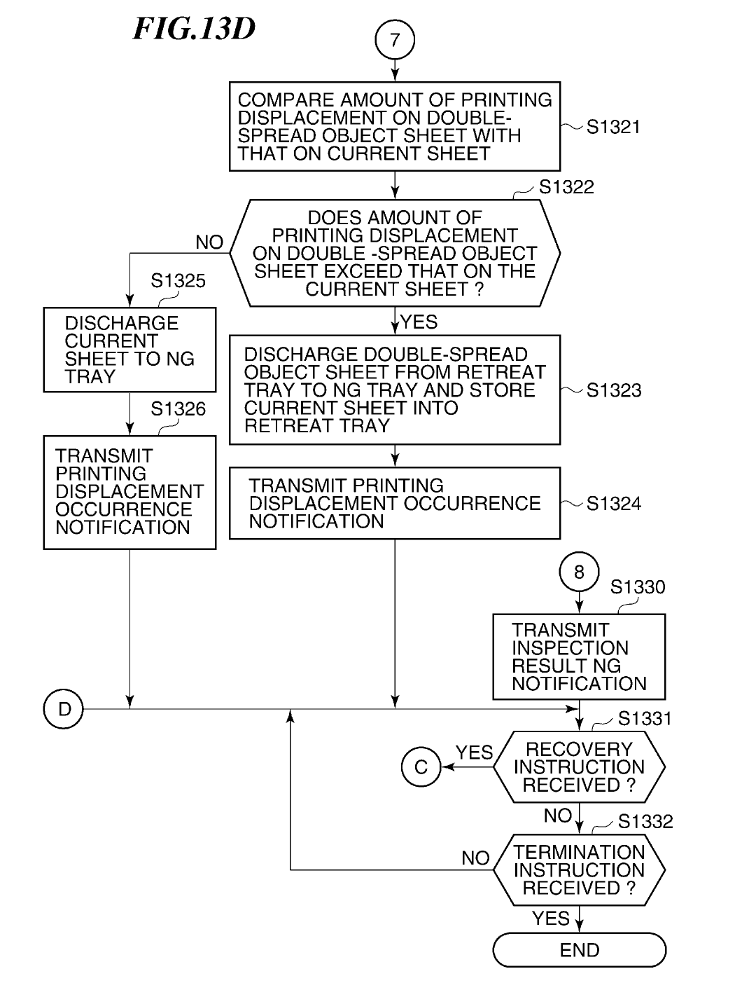

FIGS. 13A to 13D show in flowchart an inspection process performed by the inspection CPU 438 of the inspection controller 430 according to the second embodiment. This inspection process is partly similar to the inspection process in the first embodiment shown in FIGS. 9A and 9B, and a description of similar portions will be simplified.

In S1301, the inspection CPU 438 receives inspection information from the printing controller 20.

Next, the inspection CPU 438 determines whether the inspection execution mode is specified in the received information (S1302). If the answer to S1302 is No, the present process is completed. On the other hand, if the answer to S902 is Yes, the flow proceeds to S1303.

In S1303, the inspection CPU 438 receives print information from the printing controller 20.

In S1304, the inspection CPU 438 receives reference image data from the printing controller 20 and stores it into the reference image data storage unit 432.

In S1305, the inspection CPU 438 waits for a printed product being conveyed into the inspection unit 40. If it is determined that a printed product is conveyed into the inspection unit 40 (i.e., if Yes to S1305), the flow proceeds to S1306.

In S1306, the inspection CPU 438 operates the image reader 410 to scan images of both surfaces of the printed product and generate image data, and stores the image data into the scan image data storage unit 433. Further, the inspection CPU 438 operates the extraction correction unit 434 to extract image data of the sheet-equivalent scan image portion from the image data to generate scan image data (second image data).

Then, the inspection CPU 438 inputs the scan image data of the front or rear surface extracted in S1306 (hereinafter, referred to as the current scan image data) and the reference image data into the printing displacement amount calculation unit 435, and causes the calculation unit 435 to detect an amount of printing displacement (S1307). At that time, the calculation unit 435 detects the amount of printing displacement in the form of a vector that represents a displacement direction and an amount of displacement.

Next, the inspection CPU 438 stores the amount of printing displacement detected in S1307 into the RAM 440 (S1308).

Next, based on the content of finishing mode set in the print information received in S1303, the inspection CPU 438 determines whether the saddle-stitching book-binding mode is specified for the current scan image data (S1309). If the answer to S1309 is Yes, the flow proceeds to S1310.

In S1310, the inspection CPU 438 determines whether the current scan image data corresponds to middle innermost pages based on the number of pages of document specified in the received print information.

If it is determined in S1310 that the scan image data does not correspond to the middle innermost pages, the inspection CPU 438 determines whether the inspection object page is a page where there is an image in the folded portion surrounding area (S1311). If the answer to S1311 is Yes, the inspection CPU 438 causes the printing displacement correction unit 436 to compare the amount of printing displacement detected in S1307 and the book-binding printing displacement allowable value specified in the inspection information (S1312).

If the saddle-stitching book-binding mode is not specified in the received print information (i.e., if No to S1309), or if the current scan image data corresponds to the middle innermost pages (i.e., if Yes to S1310), or if the inspection object page is a page where there is no image in the folded portion surrounding area (i.e., if No to S1311), the inspection CPU 438 causes the printing displacement correction unit 436 to compare the amount of printing displacement detected in S1307 with the printing displacement allowable value specified in the inspection information (S1313). After completion of the processing in S1312 or S1313, the flow proceeds to S1314.

In S1314, the inspection CPU 438 determines whether the amount of printing displacement, which is represented by the magnitude of a vector as mentioned in the explanation for S1307, exceeds the allowable value (first determination) based on a result of the comparison in S1312 or S1313.

If it is determined in S1314 that the amount of printing displacement exceeds the allowable value (i.e., if the amount of printing displacement falls outside the allowable range), the inspection CPU 438 transmits a printing displacement occurrence notification to the printing controller 20 (S1315), and proceeds to S1331.

On the other hand, if it is determined in S1314 that the amount of printing displacement does not exceed the allowable value (i.e., if the amount of printing displacement falls within the allowable range), the inspection CPU 438 determines whether a sheet, which will face the sheet corresponding to the current scan image data at the book-binding process (hereinafter referred to as the double-spread object sheet), has been printed (S1316). In the example shown in FIGS. 12A to 12E, symbol Sheet2 denotes the double-spread object sheet for the sheet denoted by symbol Sheet1. If it is determined that the double-spread object sheet has not been printed (i.e., if No to S1316), the flow proceeds to S1327.

When determining in S1316 that the double-spread object sheet has been printed, the inspection CPU 438 reads from the RAM 440 an amount of printing displacement on the left or right page (left or right half) of the double-spread object sheet, which will face one of the pages of the sheet (corresponding to the current scan image data) at the book-binding process (S1317). Hereinafter, such amount of printing displacement will be referred to as the amount of printing displacement on the double-spread object sheet.

Based on the amount of printing displacement on the double-spread object sheet read in S1317 and the amount of printing displacement detected in S1307 (hereinafter, referred to as the amount of printing displacement on the current sheet), the inspection CPU 438 calculates an amount of relative printing displacement (S1318). In this embodiment, the amount of printing displacement is represented by the magnitude of a vector, as mentioned for S1307. If it is assumed that the amount of printing displacement on the double-spread object sheet read in S1317 is represented by the magnitude of vector A and the amount of printing displacement on the current sheet detected in S1307 is represented by the magnitude of vector B, the amount of relative printing displacement is calculated as the magnitude of difference vector between vector A and vector B.

In S1319, the inspection CPU 438 compares the amount of relative printing displacement calculated in S1318 with the book-binding printing displacement allowable value specified in the inspection information.

In S1320, based on a result of the comparison in S1319, the inspection CPU 438 determines whether the amount of printing displacement exceeds the allowable value, i.e., whether the amount of printing displacement falls outside the allowable value range (second determination). If the answer to S1320 is Yes, the flow proceeds to S1321.

In S1321, the inspection CPU 438 compares the amount of printing displacement (the magnitude of vector) on the double-spread object sheet read from the RAM with the amount of printing displacement (the magnitude of vector) on the current sheet detected in S1307.

In S1322, based on a result of the comparison in S1321, the inspection CPU 438 determines whether the amount of printing displacement on the double-spread object sheet exceeds the amount of printing displacement on the current sheet. If the answer to S1322 is Yes, the flow proceeds to S1323.

In S1323, the inspection CPU 438 performs control to discharge the double-spread object sheet stored in a retreat tray to an NG tray and store the current sheet into the retreat tray. Then, the inspection CPU 438 transmits to the printing controller 20 a printing displacement occurrence notification containing information that represents the page number of the double-spread object sheet where the printing displacement has occurred (S1324). Then, the flow proceeds to S1331.

Although not illustrated, if both the amount of printing displacement and the amount of relative printing displacement on a double-spread object sheet, on which recovery printing (i.e., reprinting) has been made in response to the printing displacement occurrence notification transmitted in S1324, do not exceed the allowable values, the inspection CPU 438 performs control to convey to the finisher the sheet on which recovery printing has been made and performs the processing of S1327 and the subsequent steps on the sheet stored into the retreat tray in S1323, whereby recovery printing can be performed while maintaining the order of sheets.

As a modification of this embodiment, it is possible to discharge to the NG tray, in S1323, both the double-spread object sheet stored in the retreat tray and the current sheet and transmit, at the transmission of the printing displacement occurrence notification in S1324, both the page number of the double-spread object sheet and the page number of the current sheet, as the page number where the printing displacement has occurred, to the printing controller 20.

If it is determined in S1322 that the amount of printing displacement on the double-spread object sheet does not exceed the amount of printing displacement on the current sheet, the flow proceeds to S1325.

In S1325, the inspection CPU 438 performs control to discharge the current sheet to the NG tray. Then, the inspection CPU 438 transmits to the printing controller 20 a printing displacement occurrence notification containing the page number of the current sheet where the printing displacement has occurred (S1326), whereupon the flow proceeds to S1331.

As described above, in S1321 to S1326, the inspection CPU 438 performs control to discharge to the NG tray either the double-spread object sheet or the current sheet, whichever is larger in the amount of printing displacement and transmits information about the discharged sheet to the printing controller 20, thereby making it possible to reprint the sheet. In response to the printing displacement occurrence notification in S1324 or S1326, the printing is interrupted (second print control).

If it is determined in S1320 that the amount of printing displacement does not exceed the allowable value (i.e., if the amount of printing displacement falls within the allowable range), the inspection CPU 438 causes the printing displacement correction unit 436 to perform a correction to shift the current scan image data by the amount of printing displacement, thereby generating corrected image data (third image data) (S1327).

Then, the inspection CPU 438 causes the comparison judgment unit 437 to compare the corrected image data generated in S1327 with the reference image data to detect a difference therebetween (S1328). Then, the comparison judgment unit 437 compares the difference detected in S1328 with the inspection judgment threshold value specified in the inspection information received in S1301, and determines whether the difference exceeds the threshold value (S1329).

If it is determined that the difference exceeds the threshold value (i.e., if Yes to S1329), the inspection CPU 438 transmits to the printing controller 20 an inspection result NG notification containing information specifying the page number where the inspection result NG has occurred (S1330). Then, the flow proceeds to S1331.

When determining in S1329 that the difference does not exceed the threshold value, the inspection CPU 438 determines whether the inspection on both the front and rear surfaces is completed (S1333). If the answer to S1333 is No, the flow returns to S1307 where scan image data on another surface is processed.

When determining in S1333 that the inspection on both the surfaces is completed, the inspection CPU 438 performs control to convey a double-spread object sheet, if stored in the retreat tray, to the finisher 50 (S1334), whereupon the flow proceeds to S1335.

In S1335, the inspection CPU 438 compares the number of pages specified in the print information received in S1303 with the number of inspected pages to determine whether the printing on all the pages is completed.

If it is determined that the printing on all the pages is not completed (i.e., if No to S1335), the inspection CPU 438 performs control to store the current sheet into the retreat tray (S1336), whereupon the flow returns to S1305.

On the other hand, when determining that the printing on all the pages is completed (i.e., if Yes to S1335), the inspection CPU 438 performs control to convey the current sheet to the finisher 50 (S1337), notifies the printing controller 20 of inspection completion, and completes the present process.

After transmitting the printing displacement occurrence notification to the printing controller 20 in S1315, S1324, or S1326 or after transmitting the inspection result NG notification to the printing controller 20 in S1330, the inspection CPU 438 waits for reception of a recovery instruction or a termination instruction from the printing controller 20 (S1331 or S1332).

If the recovery instruction is received (i.e., if Yes to S1331), the flow returns to S1305. If the termination instruction is received (i.e., if Yes to S1332), the present process is completed.

As described above, according to the second embodiment, it is possible to change the printing displacement allowable value for each sheet, which will be subjected to the saddle-stitching book-binding process, according to whether the sheet is a sheet that constitutes middle innermost pages, and inspect defective printing based on the amount of relative printing displacement on the current sheet and the double-spread object sheet. Accordingly, it is possible to improve the printing quality and at the same time reduce the printing failure occurrence rate in the printing apparatus, which is capable of inspecting defecting printing of sheets to be subjected to the saddle-stitching book-binding process.

### Other Embodiments

In the first and second embodiments, the arrangement has been described where the inspection information (such as inspection execution mode/inspection off mode, inspection judgment threshold value, printing displacement allowable value, and book-binding printing displacement allowable value) is set on the printer drive setting screen of the host computer and transmitted to the printing controller 20. Alternatively, the inspection information can be set on the operation unit 30 of the printing apparatus 70.

A scanner unit can be provided in the printing apparatus 70 to perform the inspection of a copy job where image data read by the scanner unit is printed by the printer engine 10. It is also possible to provide a storage unit (such as a hard disk drive for storing image data) in the printing apparatus 70 to perform the inspection of a print job (box print job), which is performed based on image data stored in the storage unit. To perform the inspection of a copy job or a box print job, inspection information is set on the operation unit 30 of the printing apparatus 70.

In the embodiments, it is configured that the inspection judgment threshold value, the printing displacement allowable value, and the book-binding printing displacement allowable value can arbitrarily be set. Alternatively, it is possible to configure that fixed values are stored in, e.g., the ROM 439 of the inspection controller 430.

In the embodiments, the reference image data is created by the printing controller 20. Alternatively, it is possible to configure that the reference image data created by the host computer 90 is transmitted directly to the inspection controller 430 or transmitted via the printing controller 20 to the inspection controller 430.

In the embodiments, it is configured that when a printing displacement has occurred, printing displacement information is displayed on the operation unit 30 and either recovery printing or printing interruption is selected on the operation unit 30. Alternatively, it is possible to configure that printing displacement information is transmitted from the inspection controller 430 to the host computer 90 and either recovery printing or printing interruption is selected on the host computer 90.

In the embodiments, it is configured that when an inspection result NG has occurred, an inspection result is displayed on the operation unit 30 and either recovery printing or printing interruption is selected on the operation unit 30. Alternatively, it is possible to configure that an inspection result is transmitted from the inspection controller 430 to the host computer 90 and either recovery printing or printing interruption is selected on the host computer 90.

In the embodiments, the folded portion surrounding area has a width which is the same as the book-binding printing displacement allowable value, but this is not limitative. The width of the area can be set to a value different from the book-binding printing displacement allowable value.

In the embodiments, it is determined whether the inspection object page is a page where there is an image in the folded portion surrounding area, while referring to reference image data. Alternatively, such determination can be performed while referring to scan image data. It is possible to configure that the determination is performed in advance by the printing controller 20, a result of the determination is transmitted as apart of inspection information to the inspection controller 430, and based on the received information, the inspection controller 430 determines whether the inspection object page is a page where there is an image in the folded portion surrounding area. It is also possible to configure that the host computer 90 determines whether the inspection object page is a page where there is an image in the folded portion surrounding area, information representing a result of the determination is transmitted directly to the inspection controller 430 or transmitted, as part of a print job, to the printing controller 20 from which the information is transmitted as inspection information to the inspection controller 430, and based on the information, the inspection controller 430 determines whether the inspection object page is a page where there is an image in the folded portion surrounding area.

In the embodiments, the arrangement has been described where the inspection controller 430 performs the determination on printing displacement and inspection judgment. Alternatively, it is possible to configure that scan image data is transmitted from the inspection controller 430 to the printing controller 20 and the determination on printing displacement and inspection judgment is performed by the printing controller 20.

In the embodiments, the arrangement has been described where when a printing displacement or an inspection result NG has occurred, reprinting or printing interruption is performed in accordance with user's selection of either recovery printing or printing termination on the operation unit 30. Alternatively, it is possible to configure that either reprinting or printing termination is set in advance as an operation to be performed when a printing displacement or an inspection result NG has occurred.

In the embodiments, a so-called in-line type arrangement has been described where the inspection unit 40 is incorporated in the printing apparatus 70, but this is not limitative. The inspection unit 40 and the printing apparatus 70 can be configured as separate units.

As described above, the printing apparatus of this invention is configured that the printing quality of double-spread pages on which there is an image extending across two sheets at saddle-stitching book-binding printing is inspected using a printing displacement allowable value stricter than that for other pages, whereby a printed-out product having excellent appearance can be obtained and the printing failure occurrence rate can be suppressed from increasing to prevent increase in printing cost and reduction in productivity. Accordingly, it is possible to improve the printing quality and at the same time reduce the printing failure occurrence rate in the printing apparatus, which is capable of inspecting defecting printing of sheets to be subjected to the saddle-stitching book-binding process. As a result, a printed-out product having excellent appearance can be obtained, while suppressing increase in the printing failure occurrence rate at book-binding printing, even if the printed-out product includes double spread pages where there is an image extending across two sheets.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-016571, filed Jan. 28, 2010, which is hereby incorporated by reference herein in its entirety.

What is claimed is:

1. A printing apparatus comprising:
a printing unit configured to perform printing on plural sheets based on first image data;
a reading unit configured to read plural images printed on the sheets printed by said printing unit and create second image data based on a result of reading the plural images;
a detection unit configured to detect, by comparing the first image data and the second image data, an amount of printing displacement on each of the plural printed sheets;
a determination unit configured to determine whether the amount of printing displacement on each of the sheets detected by said detection unit falls within an allowable range defined by an allowable value; and
a control unit configured, in a case where a saddle-stitching process, in which a plurality of printed sheets are folded into two and stitched together, is specified in printing settings used for the printing performed based on the first image data, to perform control to change the allowable value between a particular sheet on which an image is printed in a peripheral area around a folded sheet portion and a sheet other than the particular sheet.

2. The printing apparatus according to claim 1, wherein the particular sheet is a sheet other than an innermost sheet among the plurality of printed sheets subjected to the saddle-stitching process.

3. The printing apparatus according to claim 1, wherein the allowable value for the particular sheet does not exceed the allowable value for the sheet other than the particular sheet.

4. The printing apparatus according to claim 1, further including:
a setting unit configured to set the allowable value for the particular sheet and the allowable value for the sheet other than the particular sheet.

5. The printing apparatus according to claim 1, further including:
a first print control unit configured to control said printing unit to interrupt the printing in a case where it is determined by said first determination unit that the amount of printing displacement falls outside the allowable range.

6. The printing apparatus according to claim 5, wherein in a case where it is determined that the amount of printing displacement falls outside the allowable range and the printing is interrupted, said first print control unit controls said printing unit to reprint a sheet corresponding to the sheet for which the amount of printing displacement is determined as falling outside the allowable range.

7. The printing apparatus according to claim 5, wherein in a case where it is determined that the amount of printing displacement falls outside the allowable range and the printing is interrupted, said first print control unit notifies an operator that a printing displacement has occurred, accepts a selecting operation to select either execution of reprinting a sheet corresponding to the sheet for which the amount of printing displacement is determined as falling outside the allowable range or termination of the printing, and controls said printing unit to reprint the sheet or terminate the printing according to the selecting operation.

8. The printing apparatus according to claim 5, further including:
a printing displacement correction unit configured to perform correction to shift the second image data by the amount of printing displacement detected by said detection unit to create third image data in a case where it is determined by said first determination unit that the amount of printing displacement falls within the allowable range; and
a comparison judgment unit configured to compare the third image data created by said printing displacement correction unit with the first image data to detect a difference between the third image data and the first image data, and determine whether the detected difference is larger than a threshold value,
wherein said first print control unit controls said printing unit to interrupt the printing in a case where it is determined by said comparison judgment unit that the difference is larger than the threshold value.

9. The printing apparatus according to claim 8, wherein in a case where it is determined by said comparison judgment unit that the difference is larger than the threshold value and the printing is interrupted, said first print control unit controls said printing unit to reprint a sheet corresponding to the sheet for which the difference is determined as being larger than the threshold value.

10. The printing apparatus according to claim 8, wherein in a case where it is determined by said comparison judgment unit that the difference is larger than the threshold value and the printing is interrupted, said first print control unit notifies an operator that a printing failure has occurred, accepts a selecting operation to select either execution of reprinting the sheet corresponding to the sheet for which the difference is determined as being larger than the threshold value or termination of the printing, and controls said printing unit to reprint the sheet or terminate the printing according to the selecting operation.

11. The printing apparatus according to claim 1, further including:
a storage unit configured to store the amount of printing displacement detected by said detection unit;
a calculation unit configured, in a case where the sheet corresponds to the particular sheet, to calculate an amount of relative printing displacement from the amount of printing displacement detected by said detection unit and an amount of printing displacement, which is stored in said storage unit, on a double-spread object sheet for the sheet corresponding to the particular sheet; and
a second judgment unit configured to determine whether the amount of relative printing displacement calculated by said calculation unit falls within an allowable range.

12. The printing apparatus according to claim 11, further including:
a second print control unit configured to control said printing unit to interrupt the printing in a case where it is determined by said second judgment unit that the amount of relative printing displacement falls outside the allowable range.

13. The printing apparatus according to claim 12, wherein in a case where the amount of relative printing displacement is determined as falling outside the allowable range and the printing is interrupted, said second print control unit controls said printing unit to reprint a sheet corresponding to the double-spread object sheet and the particular sheet for which the amount of relative printing displacement is determined as falling outside the allowable range.

14. The printing apparatus according to claim 12, wherein in a case where it is determined that the amount of relative printing displacement falls outside the allowable range and the printing is interrupted, said second print control unit notifies an operator that a printing displacement has occurred, accepts a selecting operation to select either execution of reprinting the sheet corresponding to the double-spread object sheet and the particular sheet for which the amount of relative printing displacement is determined as falling outside the allowable range, or termination of the printing, and controls said printing unit to reprint the sheet or terminate the printing according to the selecting operation.

15. The printing apparatus according to claim 12, further including:
a printing displacement correction unit configured to perform correction to shift the second image data by the amount of printing displacement detected by said detection unit to create third image data in a case where it is determined by said first determination unit that the amount of printing displacement falls within the allowable range or in a case where it is determined by said second judgment unit that the amount of relative printing displacement falls within the allowable range; and
a comparison judgment unit configured to compare the third image data created by said printing displacement correction unit with the first image data to detect a difference between the third image data and the first image data, and determine whether the detected difference is larger than a threshold value,
wherein said second print control unit controls said printing unit to interrupt the printing in a case where it is determined by said comparison judgment unit that the difference is larger than the threshold value.

16. The printing apparatus according to claim 15, wherein in a case where it is determined by said comparison judgment unit that the difference is larger than the threshold value and the printing is interrupted, said second print control unit controls said printing unit to reprint a sheet corresponding to the sheet for which the difference is determined as being larger than the threshold value.

17. The printing apparatus according to claim 15, wherein in a case where it is determined by said comparison judgment unit that the difference is larger than the threshold value and the printing is interrupted, said second print control unit notifies an operator that a printing failure has occurred, accepts a selecting operation to select either execution of reprinting a sheet corresponding to the sheet for which the difference is determined as being larger than the threshold value or termination of the printing, and controls said printing unit to reprint the sheet or terminate the printing according to the selecting operation.

18. The printing apparatus according to claim 1, wherein the first image data is created based on print data input from a host computer or based on an image read from an original.

19. A printing method comprising:
a printing step of performing printing on plural sheets based on first image data;
a reading step of reading plural images printed on the sheets printed in said printing step and creating second image data based on a result of the reading;
a detection step of detecting, by comparing the first image data and the second image data, an amount of printing displacement on each of the plural printed sheets;
a determination step of determining whether the amount of printing displacement on each of the sheets detected in said detection step falls within an allowable range defined by an allowable value; and
a control step of, in a case where a saddle-stitching process, in which a plurality of printed sheets are folded into two and stitched together, is specified in printing settings used for the printing performed based on the first image data, performing control to change the allowable value between a particular sheet on which an image is printed in a peripheral area around a folded sheet portion and a sheet other than the particular sheet.

20. A non-transitory computer-readable storage medium storing a program for causing a computer to execute the printing method as set fourth in claim 19.

21. A printing apparatus comprising:
a printing unit configured to perform printing on plural sheets based on first image data;
a reading unit configured to read plural images printed on the sheets printed by said printing unit and create second image data based on a result of reading the plural images;
a detection unit configured to detect, by comparing the first image data and the second image data, an amount of printing displacement on each of the plural printed sheets;
a determination unit configured to determine whether the amount of printing displacement on each of the sheets detected by said detection unit falls within an allowable range defined by an allowable value; and
a control unit configured to change the allowable value based on whether or not a saddle-stitching process, in which a plurality of printed sheets are folded into two and stitched together, is specified in printing settings used for the printing performed based on the first image data.
